(19) United States
(12) Patent Application Publication
(10) Pub. No.: US 2013/0064626 A1
(43) Pub. Date: Mar. 14, 2013

(54) Method and Device for Gathering Loose Book Blocks

(71) Applicants: Kai Büntemeyer, Rahden (DE); Karl-Heinz Döpke, Rahden (DE); Thomas Klarhorst, Lemgo (DE)

(72) Inventors: Kai Büntemeyer, Rahden (DE); Karl-Heinz Döpke, Rahden (DE); Thomas Klarhorst, Lemgo (DE)

(21) Appl. No.: 13/590,327

(22) Filed: Aug. 21, 2012

(30) Foreign Application Priority Data
Sep. 10, 2011 (DE) 10 2011 113 050 4
Apr. 14, 2012 (DE) 10 2012 008 236 3

(51) Int. Cl. B65H 39/00; B42C 99/00

(52) U.S. Cl. 412/1; 412/9

(57) ABSTRACT

In a method and associated device for gathering loose book blocks (B, B_{1 . . . 7}), loose partial blocks (B, TB) formed of at least two serially printed signatures (7) to be arranged consecutively in a book block (B) are delivered to transport segments (3) with the aid of at least one feeder (10.1 . . . 3) by successively removing the at least two signatures (7) from a magazine (11) of the at least one feeder (10.1 . . . 3).

### BACKGROUND

The present invention pertains to a method and a device for gathering loose book blocks consisting of single-page or multi-page signatures such as folded sections and/or single sheets, with a gathering section, with a revolving conveying device that features equidistantly and consecutively arranged transport segments, and with several feeders that are arranged along the gathering section and serve for feeding the signatures to the transport segments.

In the production of bound book blocks and brochures, signatures such as folded sections and/or single sheets are gathered into loose book blocks, bound by means of perfect binding, wire stapling or thread sewing and, if applicable, provided with a cover or a lining strip. Identical folded sections or single sheets are respectively situated in the feeders of the gathering machine or their magazines, respectively. In conventional gathering processes, a single signature is respectively removed in succession from the individual magazines and fed to the gathering section in order to successively form the loose book blocks.

When processing contents printed on digital printing machines, the gathering process is no longer required because all pages of a book block are printed in sequence and stacked into a loose book block. However, the loose book blocks need to be transferred to a downstream binder in sound condition and this undamaged transfer is associated with a significant logistic effort. The loose book blocks usually consist of single sheets or quarter sections only and can easily fall apart during their transport such that they are no longer arranged in order. In this respect, EP 2 159 070 A1 proposes to glue the individual digitally printed signatures into a provisionally bound book block with the aid of a glue connection near the joint. Although this simplifies the handling of the book blocks, the alternative glue connection increases the production costs and ultimately needs to be removed again during the final binding of the respective brochures or book blocks.

The book blocks frequently are still transferred from the digital printing machine to the binder in a manual fashion and loosely layered on top of one another on transport carts or pallets. Due to the low stability of the stacked piles, the storage capacity is limited and intermediate storage capacities are quickly exhausted. There also is a risk of confusion if different book blocks with approximately identical format are processed. In systems, in which the digital printing machine and the binder are linked to one another inline, it is problematic that the printing capacity of the digital printing machines needs to be divided by the respectively printed total paper surface of the book block to be produced while the binding capacity refers to the book block unit. An inline coupling can only be synchronized for a very limited format spectrum. At different formats and numbers of pages of the book blocks to be produced, significant and therefore uneconomical performance discrepancies exist to some extent within the inline coupling such that the potential capacity of either the digital printing machine or the binder is restricted.

It should be noted that no economically sensible solution for the intermediate storage and the inter-system transport of the loose book blocks has been proposed so far. On the other hand, there exist a number of conventional perfect binding production lines with a perfect binder that is directly connected to a gathering machine of the initially cited type. When processing digitally printed loose book blocks, the gathering machine remains unused and the delivery of the book blocks is instead painstakingly realized by means of a manual feed. It would therefore be desirable to realize the handling of digitally printed contents between digital printing machines and binders in an operationally reliable, efficient and automatable fashion.

### SUMMARY

The invention is based on the objective of developing a method and a device for gathering loose book blocks that respectively allow fail-safe and efficient logistics between digital printing machines and binders and make it possible to realize the delivery by means of the gathering machine and without a manual feed.

According to the disclosed method, loose partial blocks of at least two serially printed signatures to be arranged consecutively in a book block are fed to the transport segments with the aid of at least one feeder by successively removing the at least two signatures from a magazine of the at least one feeder.

Serially printed signatures can be placed into the magazine of the feeder in the form of a quasi infinite stack. The separation or the separate handling of individual book blocks can be eliminated. The book blocks or partial blocks thereof do not have to be layered on top of one another in a mutually offset fashion.

Due to the sequential separation of serially printed signatures, the respective signatures intended for a book block or partial block can be removed from the quasi infinite stack in an exactly counted fashion. Within the stack, the first signature of the next partial block follows the last signature of the preceding partial block. The next partial block may be identical to the preceding partial block if an edition of identical book blocks is processed or a book block that has the same format, but a different content and, if applicable, a different number of signatures alternatively follows. The respective information on the number of signatures to be separated per partial block may be stored in a control device and/or quasi read out of the signatures based on identifiable characteristics. This simultaneously makes it possible to realize a completeness check of the respective book block or partial block that could not be carried out in the previous handling of digitally printed book blocks.

It is also possible to use the same logistic (storage) devices as with conventionally printed signatures, in which case identical signatures are stored in rolls, bundles, etc. Serially printed signatures that are stored in this fashion can be transported and intermediately stored in a significantly safer fashion such that inter-system processing becomes possible and larger storage capacities can be used.

In the disclosed device, the feeder of the gathering machine is realized in the form of a counting feeder that serves for separating the respectively required number of signatures to be arranged consecutively in a book block and for transferring the signatures to the transport segments of the gathering section stack-by-stack.

### BRIEF DESCRIPTION OF THE DRAWING

The salient characteristics of the present invention are elucidated in the following description of several exemplary embodiments that are illustrated in the attached drawing. In this drawing:

FIG. 1 shows a detail of two feeders of a gathering machine in the form of a side view;

FIG. 2a shows a section through an intermediate magazine of the feeders according to definition II-II in FIG. 1;

FIG. 2b shows an identical section through an intermediate magazine with optional intermediate level;

FIG. 3 shows a feeder with a downstream ramp conveying device;

FIG. 4a schematically shows a first gathering process;

FIG. 4b schematically shows a second gathering process;

FIG. 5a schematically shows the manual filling of a feeder magazine;

FIG. 5b schematically shows the filling by means of a bundle feeder;

FIG. 5c schematically shows an inline coupling with a digital printing machine;

FIG. 5d schematically shows a coupling with a folding device;

FIG. 6 shows a side view of a bundle feeder connected to the magazine according to definition VI-VI in FIG. 1; and

FIG. 7 shows a side view of two feeders with a common intermediate magazine.

### DETAILED DESCRIPTION

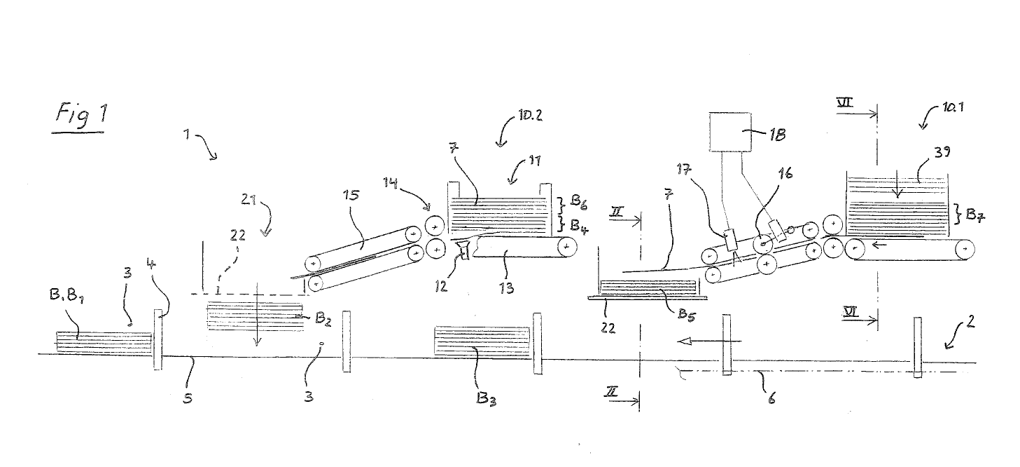

FIG. 1 shows a detail of a gathering machine 1, in which book blocks B are gathered in order to be transferred to a downstream binder such as, e.g., a perfect binder. The gathering machine 1 features a gathering section 2 that consists of a transport channel 5 and pushers 4 of a continuously revolving conveyor chain 6 that extend through the transport channel 5 and are arranged at defined distances from one another. The book blocks B are pushed onward by the pushers 4 such that transport segments 3 for the book quasi blocks B are formed in front of the respective pushers 4. However, the transport segments 3 may also consist of transport trays or the like that are driven continuously or intermittently.

Feeders 10.1, 10.2 are arranged along the gathering section 2 and oriented in the moving direction of the gathering section 2. Each feeder 10.1, 10.2 features a magazine 11 that serves for accommodating stacked signatures 7 and features a suction belt 13 that forms the magazine bottom. The width of this suction belt is chosen such that the signatures 7 protrude over the suction belt 13 by a defined length with their spine region in order to take hold of and tip the bottom signature 7 by means of a suction element 12. The thusly separated signature 7 is pushed from the magazine 11 to a pair of pull-off rollers 14 by the suction belt 13 that moves back and forward in a cyclic fashion, wherein a downwardly inclined clamping belt conveyor 15 is arranged directly downstream of the pair of pull-off rollers. In a conventional gathering process, the separated signatures 7 are fed to the transport segments 3 in order to form the book block, wherein each feeder 10.1, 10.2 only delivers a single signature in order to form a book block.

According to the invention, loose partial blocks consisting of at least two serially printed signatures 7 to be arranged consecutively in a book block are fed to the transport segments 3 with the aid of at least one feeder 10.1, 10.2. The at least two signatures 7 are successively removed from the magazine 11 of the at least one feeder 10.1, 10.2.

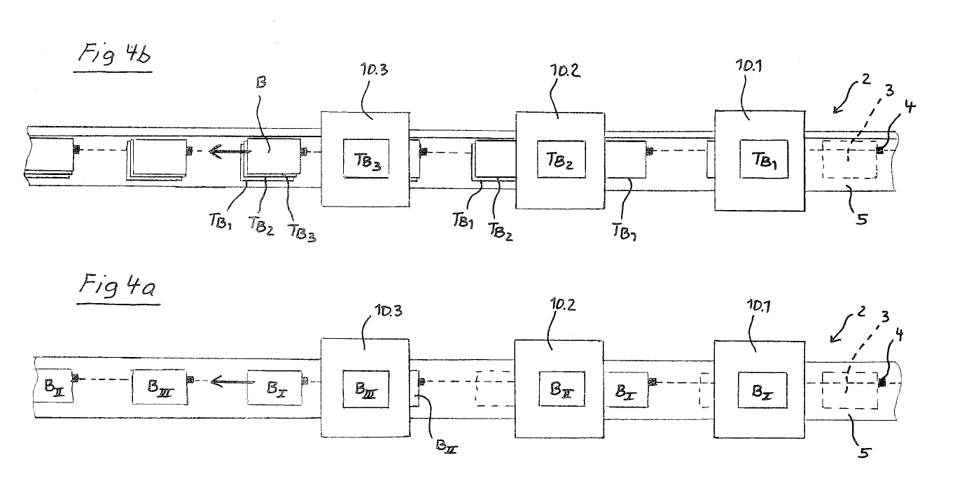

The gathering process apparent from FIG. 1 is schematically illustrated in FIG. 4a. One complete book block B_{I}, B_{II}, B_{III} is respectively delivered to the gathering section 2 by each of the feeders 10.1, 10.2, 10.3, wherein each book block is respectively placed in front of a vacant pusher 4. A still vacant transport segment 3 is visualized in the form of a frame drawn with broken lines in FIG. 4a. The feeder 10.1 delivers book blocks B_{I}, the feeder 10.2 delivers book blocks B_{II}and the feeder 10.3 delivers book blocks B_{III}. The book blocks B_{I}, B_{II}, B_{III} may consist of identical book blocks B of an edition of several book blocks that have the same content, i.e., each feeder 10.1, 10.2, 10.3 delivers identical book blocks to the gathering section 2.

However, the book blocks may also have different contents and, if applicable, differ with respect to their number of pages. This scenario is apparent from FIG. 1. The different book blocks are identified as book blocks B₁ to B₇. The book blocks B₁ and B₃ are already situated on the gathering section 2 while another book block B₂ is dropped onto a thus far vacant transport segment 3 of the gathering section 2 in the instant shown. The other book blocks B₄ to B₇ respectively are still situated in the magazines 11 of the two feeders 10.1, 10.2 or separated from the magazines 11.

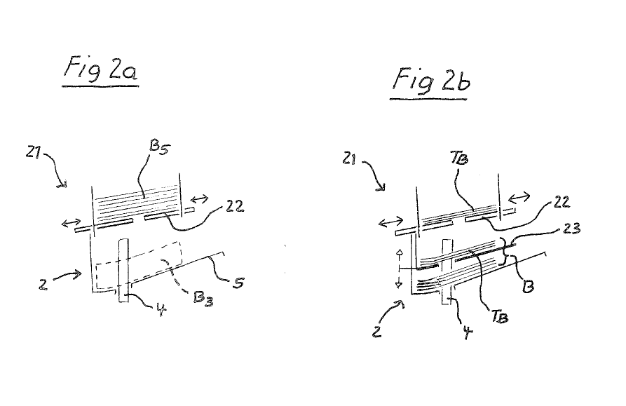

In contrast to a conventional gathering process, the respective signature 7 separated from the magazines 11 is not directly delivered to the transport segment 3, but rather initially stacked into the partial block or the respective book block, namely the book block B₅ in FIG. 1, together with subsequently separated signatures 7 in an intermediate magazine 21, wherein said partial block or book block is then dropped onto a vacant transport segment 3 by opening the magazine bottom 22 In this context, see also FIG. 2a.

FIG. 4b shows an alternative gathering process. In this case, partial blocks TB₁, TB₂ and TB₃ are respectively delivered to the gathering section 2 by the feeders 10.1, 10.2, 10.3. In the gathering section 2, the partial blocks TB₁, TB₂ and TB₃ are stacked on top of one another in order to form the book block B. FIG. 2b shows the intermediate magazine 21 with an additional intermediate level 23, on which partial blocks TB formed in the intermediate magazine 21 can be deposited and from which the partial blocks TB are removed by the pushers 4 of the gathering section 2 in order to form stacks. The height of the intermediate level 23 can be adjusted in accordance with the thickness of the book block formed so far in the gathering section 2.

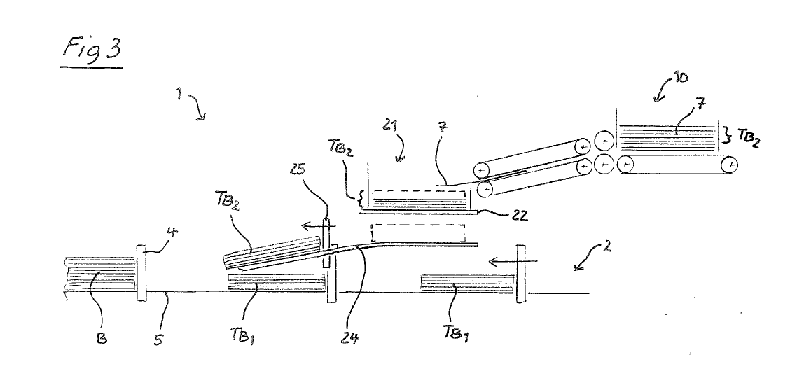

FIG. 3 shows a feeder 10 with a downstream ramp conveying device. Book blocks or partial blocks TB₂ formed in the intermediate magazine 21 are deposited onto a ramp 24 that lies above the pushers 4. The book blocks or partial blocks TB₂ are pre-accelerated to approximately the transport speed of the gathering section 2 by means of a separately driven pusher 25 and moved into the transport path of the pushers 4 of the gathering section 2 on a downwardly inclined segment of the ramp 24, wherein the book blocks or partial blocks are ultimately received by the pushers of the gathering section without jerk and, if applicable, gathered into the book block B together with other partial blocks TB₁.

According to the invention, the gathering or the stack formation is at least partially shifted from the gathering section 2 into the respective feeder 10.1, 10.2, 10.3, wherein this provides the advantage that serially printed signatures 7 as they occur in digital printing can also be placed into the magazines 11 of the feeders 10.1, 10.2, 10.3. Due to the sequential separation, the respective signatures 7 that belong to a book block B or partial block TB are removed from the quasi infinite stack in the magazines 11 in an exactly counted fashion and delivered to the gathering section 2 stack-by-stack.

High feed capacities can be achieved due to the parallelization of the processes with a number of feeders 10.1, 10.2, 10.3 that are arranged along the gathering section 2 (as described above). Similar to conventional gathering processes, several feeders 10.1, 10.2, 10.3 can be used for book blocks B that feature a larger number of signatures 7.

On the other hand, it is also possible to combine digitally printed contents with conventionally printed contents, e.g., in that a first feeder 10.1 delivers a first partial block TB₁ consisting of several serially printed signatures 7, a second, conventionally operated feeder 10.2 deposits an offset-printed signature in front of the pushers 4 and a third feeder 10.3 once again delivers a digitally printed partial block TB₂.

FIG. 7 shows an alternative option for combining signatures 7, 7a produced by different printing machines with one another in order to form a book block B. Two feeders 10a, b are assigned to a common intermediate magazine 21′ and deliver the respective signatures 7, 7a to the intermediate magazine 21′ in a certain sequence. For example, the feeder 10a delivers signatures 7 that were serially printed in black and white to the intermediate magazine 21′ while the feeder 10b deposits signatures 7a that were serially printed in color. In the intermediate magazine 21′, the signatures 7, 7a are stacked on top of one another in the desired sequence in order to form the book block B, namely in that the separation process at the feeder 10a is respectively interrupted for a brief period of time in order to intermediately insert one or more color signatures 7a delivered by the feeder 10b. The book block B formed in the intermediate magazine 21′ is ultimately deposited onto a vacant transport segment 3 in the above-described fashion by opening the magazine bottom 22.

The control of the gathering processes is realized with a master control unit 18 (see FIG. 1). Barcode scanners 17 arranged in the region of the clamping belt conveyors 15 acquire characteristics of the signatures 7 that are encrypted in a barcode. Different manifestations of the control can be realized.

A predetermined sequence of the signatures and book blocks in the magazines and feeders may be stored in a data memory of the control unit 18, wherein the signatures are removed from the different magazines and the book blocks or partial blocks are transferred to the transport segment 3 in this predetermined sequence such that the thusly formed complete book blocks B₁ to B₇ reach the perfect binder in the sequence, in which the corresponding covers are also fed to the perfect binder. The proper sequence and the completeness of the book blocks B is checked by identifying the respective signatures 7 with the aid of the barcode scanner 17.

The required information on the respective next book block separated from the magazines may also be stored in the barcode of the first signature of a respective new book block B or partial block TB and quasi made available to the control unit 18 and the downstream binder by the signature 7.

An additional thickness measuring device 16 on the clamping belt conveyor 15 makes it possible to determine the total thickness of the respective book block B or partial block TB separated from the magazine 11 by adding the measured individual thicknesses of the signatures 7 that successively pass the thickness measuring device 16. The total thickness can be used for adjusting downstream transport and processing devices.

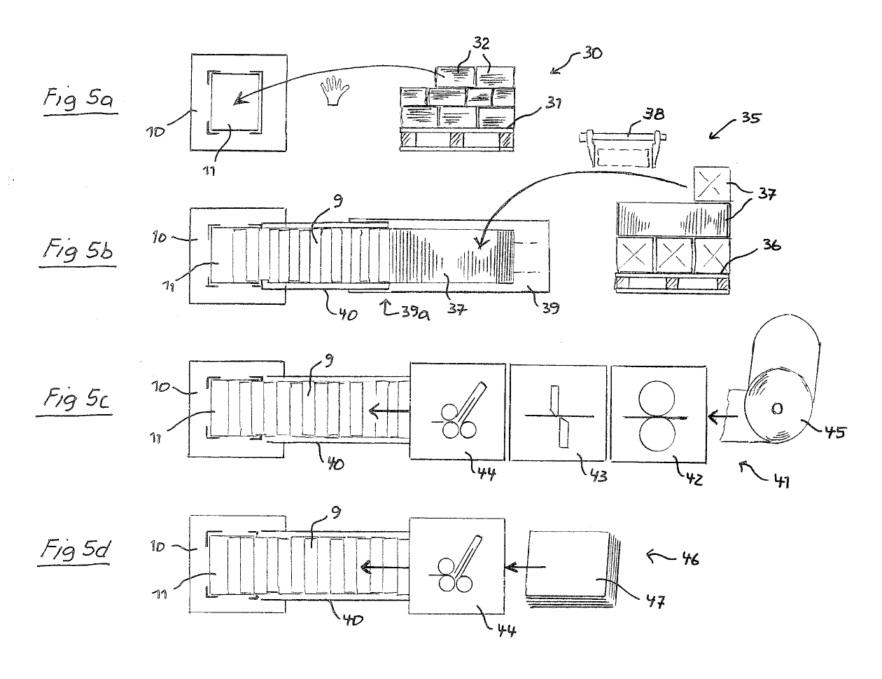

FIGS. 5a to 5d show different options for filling the magazines 11 of the feeders 10 with signatures 7.

FIG. 5a shows a manual loading process 30. Stacks 32 that are layered on top of one another on a pallet 31 are manually placed into the magazines 11. The stacks 32 may comprise one or more book blocks B or partial blocks TB, wherein the individual book blocks B or partial blocks TB respectively do not have to be offset relative to one another in the stack 32 because the respective book blocks are not handled individually. Consequently, several book blocks can be placed into the respective magazine 11 in a single manual feeding process such that this type of manual loading is much more efficient than the manual feed of individual book blocks into the intake of the binder. One operator even can fill several magazines 11 simultaneously.

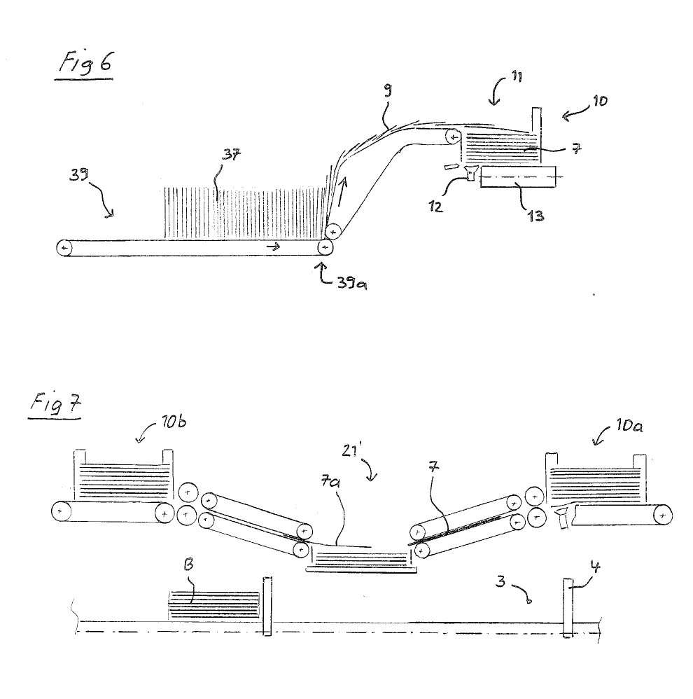

FIG. 5b shows a bundle feeder 35, in which signatures 7 banded in signature bundles 37 are processed. The signature bundles 37 are removed from a pallet 36 and placed onto a bundle feeder 39 with the aid of grippers 38 and pushed together with the preceding bundle after removing the banderole in order to form an endless bundle. According to FIG. 6, the endless bundle is pushed against a deimbricating point 39a, from which the signatures 7 are removed in the form of an imbricated stream 9 and delivered to the magazine 11 by means of a conveyor belt 40. The signature bundles 37 are known from conventional postpress processing and provide enormous storage capacities, as well as a high degree of automation. Instead of only identical signatures, serially printed signatures are folded at the exit of a digital web-fed printing machine and conventionally stacked and banded in signature bundles 37.

FIG. 5c shows an inline coupling 41 of the feeder 10 with a digital printing machine 42, wherein a paper web unrolled from the paper reel 45 is printed, for example, in an endless fashion. The paper web is crosscut inline by means of a cross cutter 43, wherein the individual sections are folded into the signatures 7 in a folding device 44 and delivered in the form of an imbricated stream 9. The imbricated stream 9 is directly delivered into the magazine 11 of the feeder 10 by said conveyor belt 40. Signatures 7 transported in the imbricated stream 9 can be transported and delivered to the magazines 11 in a much more fail-safe fashion than in instances, in which loose book blocks B delivered by the digital printing machine in the form of stacks are fed to the transfer device of the binder inline.

FIG. 5d shows the coupling 46 of the feeder 10 to the folding device 44 only. Serially printed signatures 47 are folded in the folding device 44 and delivered to the magazine 11 of the feeder 10 in the form of an imbricated stream 9. It is easier to realize the transport of large-format signatures 47, particularly also the inter-system transport, than the transport of said loose book block stacks.

1. A method for gathering loose book blocks (B, B_{1 . . . 7}) formed of single-page or multi-page signatures (7) with a gathering section (2), a revolving conveying device (6) that features equidistantly and consecutively arranged transport segments (3), and several feeders (10.1 . . . 3) that are arranged along the gathering section (2) and for feeding the signatures (7) to the transport segments (3), comprising:
that loose partial blocks (B, TB) consisting of at least two serially printed signatures (7) to be arranged consecutively in a book block (B) are fed to the transport segments (3) with the aid of at least one feeder (10.1 . . . 3);
wherein said feeding is by successively removing the at least two signatures (7) from a magazine (11) of the at least one feeder (10.1 . . . 3).

2. The method according to claim 1, wherein the at least two signatures of the partial blocks are removed from a stack of partial blocks (B, TB) or signatures (7) accommodated in the magazine (11) of the at least one the feeder (10.1 . . . 3).

3. The method according to claim 1, wherein imbricated stream (9) of signatures (7) that lie on top of one another in an imbricated fashion is fed to the magazine (11) of the at least one feeder (10.1 . . . 3), and the imbricated stream (9) comprises successive partial blocks (B, TB) that respectively consist of at least two signatures (7) to be arranged consecutively in a book block (B).

4. The method according to claim 3, wherein the imbricated stream (9) is respectively removed or unrolled from a bundle (37) or a roll, in which the signatures (7) are stored.

5. The method according to claim 3, wherein the imbricated stream (9) is delivered by a folding machine (44) or a folding apparatus (44) of a digital printing machine (42) and fed to the magazine (11).

6. The method according to claim 1, wherein a complete book block (B, B_{1 . . . 7}) is delivered to the gathering section (2) by the at least one feeder (10.1 . . . 3).

7. The method according to claim 1, wherein identical partial blocks (B, TB) are delivered to the gathering section (2) by several feeders (10.1 . . . 3), with the partial blocks (B, TB) delivered to different transport segments (3).

8. The method according to claim 1, wherein the book blocks (B) are formed of several partial blocks (TB_{1 . . . 3}) having approximately the same number of signatures (7) and are successively delivered to the transport segments (3) by a corresponding number of feeders (10.1 . . . 3).

9. The method according to claim 1, wherein the at least two signatures (7) that are successively removed from the magazine (11) are transferred into an intermediate magazine (21) and stacked into a partial block (B, TB), and the partial block (B, TB) is delivered from the intermediate magazine (21) to the respective transport segment (3).

10. The method according to claim 9, wherein signatures (7, 7a) are delivered to the intermediate magazine (21′) by at least two feeders (10a, b) in order to form the partial blocks (B, TB).

11. The method of claim 2, wherein imbricated stream (9) of signatures (7) that lie on top of one another in an imbricated fashion is fed to the magazine (11) of the at least one feeder (10.1 . . . 3), and the imbricated stream (9) comprises successive partial blocks (B, TB) that respectively consist of at least two signatures (7) to be arranged consecutively in a book block (B).

12. The method of claim 2, wherein the at least two signatures (7) that are successively removed from the magazine (11) are transferred into an intermediate magazine (21) and stacked into a partial block (B, TB), and the partial block (B, TB) is delivered from the intermediate magazine (21) to the respective transport segment (3).

13. The method of claim 12, wherein signatures (7, 7a) are delivered to the intermediate magazine (21′) by at least two feeders (10a, b) in order to form the partial blocks (B, TB).

14. A device for gathering loose book blocks (B, B_{1 . . . 7}) formed of single-page or multi-page signatures (7) comprising:
a gathering section (2) with a revolving conveying device (6) having equidistantly and consecutively arranged transport segments (3);
a plurality of feeders (10.1 . . . 3) that respectively include a magazine (11), arranged along the gathering section for separating and feeding the signatures (7) to the transport segments (3); and
at least one feeder (10.1 . . . 3) that respectively separates at least two signatures (7) that form a partial block (B, TB) and need to be arranged consecutively in a book block (B) and that delivers the partial blocks (B, TB) to the transport segments (3).

15. The device according to claim 14, wherein the at least one feeder (10.1 . . . 3) includes an intermediate magazine (21), in which the separated signatures (7) are stacked into the partial blocks (B, TB), and the intermediate magazine (21) includes a magazine bottom (22) that can be selectively opened to deliver the partial blocks (B, TB) to the transport segments (3).

16. The device according to claim 15, wherein several feeders (10a, b) are operatively connected to the intermediate magazine (21′), whereby the signatures (7a, b) that are successfully removed from the respective magazines (11) are stackable on top of one another in a defined sequence.

17. The device according to claim 14, wherein a height-adjustable intermediate level (23) on the gathering section (2) is operatively connected to the at least one feeder (10.1 . . . 3) such that partial blocks (B, TB) formed or deposited thereon can be received by pushers (4) of the transport segments (3).

18. The device according to claim 14, wherein an intermediate level (24) arranged above the gathering section (2) is operatively connected to the at least one feeder (10.1 . . . 3) and includes a ramp (34) that is downwardly inclined in the conveying direction of the transport segments (3) for transferring the partial blocks (B, TB) to the transport segments (3).

19. The device according to claim 14, wherein a conveying device (25) is operatively connected to the at least one feeder (10.1 . . . 3) such that the partial block (B, TB) can be pre-accelerated to approximately the transport speed of the transport segments (3) and subsequently received by the transport segments (3).

20. . The device according to claim 14, wherein a conveying device (40) is arranged upstream of the at least one feeder (10.1 . . . 3) to deliver an imbricated stream (9) of signatures (7) that lie on top of one another in an imbricated fashion to the magazine (11) of the feeder (10.1 . . . 3).
